(19) United States
(12) Patent Application Publication
(10) Pub. No.: US 2009/0169855 A1
(43) Pub. Date: Jul. 2, 2009

(54) Armor Panel System

(76) Inventor: George Tunis, Berlin, MD (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/547,659

(22) PCT Filed: Apr. 5, 2005
(86) PCT No.: PCT/US05/11471

§ 371 Date: Jun. 27, 2008

Related U.S. Application Data
(60) Provisional application No. 60/560,024, filed on Apr. 5, 2004.

(51) Int. Cl. B32B 17/12; B32B 5/12; B32B 13/00; E05G 1/024

(52) U.S. Cl. 428/293.4; 428/297.4; 428/294.7; 109/50; 109/58

(57) ABSTRACT

An armor system has a hardened strike panel and a backing panel. The strike panel utilizes common hard materials such as granite, hardened concrete or ceramic tile. The backing panel utilizes reinforcement materials having high strength and stiffness to provide support to the strike panel upon impact of a projectile. A reinforcement product marketed under the trade name Hardwire™ is used in some embodiments. This reinforcement material has wire strand cords extending through a support layer that may be molded and provides superior strength to weight ratios. The backing panel also may utilize a core material with a reinforcement layer or layers attached to each face in a preferred embodiment. Staples may extend through the layers to provide additional resistance against delamination.

This application is being filed on 5 Apr. 2005, as a PCT International Patent application in the name of George Tunis, a U.S. citizen, applicant for the designation of all countries, and claims priority to U.S. Provisional Application Ser. No. 60/560,024, filed Apr. 5, 2004.

### BACKGROUND OF THE INVENTION

1. Field of the Invention

The present invention relates to armor systems, and in particular to panels and articles having a hardened face and reinforced backing.

2. Description of the Prior Art

Ballistic and blast resistant panels are well known and take on a variety of configurations for providing armor to buildings, vehicles, ships, airplanes and a variety of other applications wherein armor is required. Armor should be both ballistic resistant and blast resistant. In addition to typical projectiles, it is also desirous to stop high velocity armor piercing weapons.

Traditional armor is commonly solid metallic armor made of steel, aluminum, titanium or alloys thereof. Such solid metallic armors typically possess excellent stopping power. However, the steel and aluminum metallic armor has several drawbacks, including low weight efficiency compared to composite systems. Titanium systems typically perform better than steel and aluminum, but titanium is extremely expensive and using the material may be cost prohibitive. Although solid metal armor does have excellent multi-hit characteristics, metal armor often creates fragment projectiles on the backside of the armor that causes additional dangers. Such fragments may be widely dispersed from the solid armor and can be as dangerous or more dangerous than the initial, primary projectile.

To overcome such shortcomings, composite armors have been developed that are highly weight efficient, offering improved projectile and fragment stopping power per weight as compared to solid metal armors. However, composite armors based on ceramic strike faces with composite backing plates have heretofore included carbon, glass and Kevlar polymer composites, which are expensive and may be cost prohibitive. Moreover, since manufacturing processes for the ceramic strike faces are slow and power intensive, the resulting armor can be in short supply. Backing plates have heretofore utilized traditional fibers, typically at diameters less than 100 microns. Such fine diameter fibers for low cost, stiff and high elongation thermoplastic polymer systems have limited use, due to the inability to adequately wet the fibers at required high fiber volumes.

Innovations in reinforcements have been made utilizing ultra high strength twisted steel wires. Such material, made under the trade name Hardwire™ affords users the ability to use material that may be eleven times stronger than typical steel plate as reinforcement for many different materials. The Hardwire™ material functions as a moldable, high strength steel. The material may be molded into thermo-set, thermoplastic or cementitious resin systems. The Hardwire™ material can be used to upgrade steel, wood, concrete, rock or other materials and may be retrofit for some applications. Moreover, the inexpensive Hardwire™ material is typically priced like a glass material, while performing like carbon composites at a fraction of the cost. In addition, such composites may typically be up to 70% thinner and 20% lighter than composites made with glass fibers. The material may be molded so that it can be applied to multiple shapes for various applications.

It can be seen that a new and improved reinforced armor system is needed. Such a system should provide excellent ballistic and blast resistance. Such an armor panel system should be moldable and adaptable to multiple applications. Moreover, the armor panel system should achieve the relatively low cost of metallic armor and the weight efficiency of composite armor systems. Such an armor panel system should also provide excellent multi-hit capabilities. The present invention addresses these as well as other problems associated with armor systems.

### SUMMARY OF THE INVENTION

The present invention is directed to an armor system and in particular, to a composite armor system with a hardened strike panel and a backing panel. The strike panel or strike plate of the present invention is typically a commonly found material having high hardness, such as granite, hardened concrete or ceramic tile. A bonding layer may be applied to the outer face of the strike panel. The backing panel utilizes reinforcement materials having high strength and stiffness to provide support to the strike panel upon impact. A reinforcement product marketed under the trade name Hardwire™ was found to be especially effective. This reinforcement material has twisted wire strand cords extending through a support matrix that may be molded and provides superior strength to weight ratios. In other embodiments, wires in the backing panel are oriented as helical springs, loops, spirals and other nonlinear configurations that provide for added elongation over typical straight wires. The nonlinear configurations allow for the supporting wire or cord materials to elongate by straightening out, rather than just stretching the wires. The backing panel also may utilize a core material with a reinforcement layer or layers attached to one or both faces in a preferred embodiment. In addition, the reinforcement layers are unidirectional and preferably include multiple reinforcement layers oriented at 90 degrees to one another. Staples may extend through the layers to provide additional resistance against delamination in one embodiment. The reinforcement layers may be attached with glue, hook and loop fasteners commonly sold under the brand Velcro™, tape, and/or may be molded or sprayed to the strike face. For some applications, reinforcement layers are mounted to both sides of the strike face.

The hardened strike face acts to flatten or shatter the projectile and a cone of pulverized material is spread throughout the armor panel and through the backing panel. The backing panel absorbs and spreads out the material and supports the strike panel to resist dilation for improved multi-hit performance. The backing panel has high stiffness and strain properties to support the hardened strike panel. The armor system may be configured as a stand-alone armor assembly that may be retrofit to existing structures or it may be incorporated into walls and other surfaces.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 is a diagrammatic side view of a reinforced armor panel according to the principles of the present invention;

FIG. 2 is a diagrammatic side view of the armor panel shown in FIG. 1 with a projectile striking the panel and flattening while forming a cone of pulverizing material;

FIG. 3 is a diagrammatic side view of the armor panel shown in FIG. 1 and a projectile striking the panel with the backing panel deflecting and powder escaping;

FIG. 4 is a diagrammatic side view of a second embodiment of a reinforced armor panel according to the principles of the present invention;

FIG. 5 is a diagrammatic side view of the armor panel shown in FIG. 4 with a projectile striking the strike panel;

FIG. 6 is a diagrammatic side view of the armor panel shown in FIG. 4 with a projectile striking the strike panel and an impact cone traveling through the armor backing panel;

FIG. 7 is a diagrammatic side view of a third embodiment of a reinforced armor panel according to the principles of the present invention;

FIG. 8 is a diagrammatic side view of the armor panel shown in FIG. 7 with a projectile striking the strike panel;

FIG. 9 is a diagrammatic side view of the armor panel shown in FIG. 7 with a projectile striking the strike panel and an impact cone traveling through the armor backing panel;

FIG. 10 is a diagrammatic side view of a fourth embodiment of a reinforced armor panel according to the principles of the present invention;

FIG. 11 is a top plan view of a reinforcing structure for the armor panels shown in FIGS. 4-9;

FIG. 12 is a side elevational view of a steel wire cords for the reinforcing structure shown in FIG. 11;

FIG. 13 is a top plan view of reinforcing wires wound in a helical spring type configuration;

FIG. 14 is a top plan view of reinforcing wires wound in a flattened helical configuration;

FIG. 15 is a top plan view of reinforcing wires wound in a helical spring type configuration and intertwined;

FIG. 16 is a top plan view of reinforcing wires formed into loops;

FIG. 17 is a top plan view of high twist reinforcing wires embedded in a unidirectional tape;

FIG. 18 is a top plan view of reinforcing wires wound in a continuous spiral configuration;

FIG. 19 is a perspective view of a reinforcement panel covered with Velcro™ and a strike face panel;

FIG. 20 is a side elevational view of the reinforcement panel shown in FIG. 19 mounted to the strike face panel; and

FIG. 21 is a perspective view of the armor system shown in FIG. 20.

### DETAILED DESCRIPTION OF THE PREFERRED EMBODIMENT

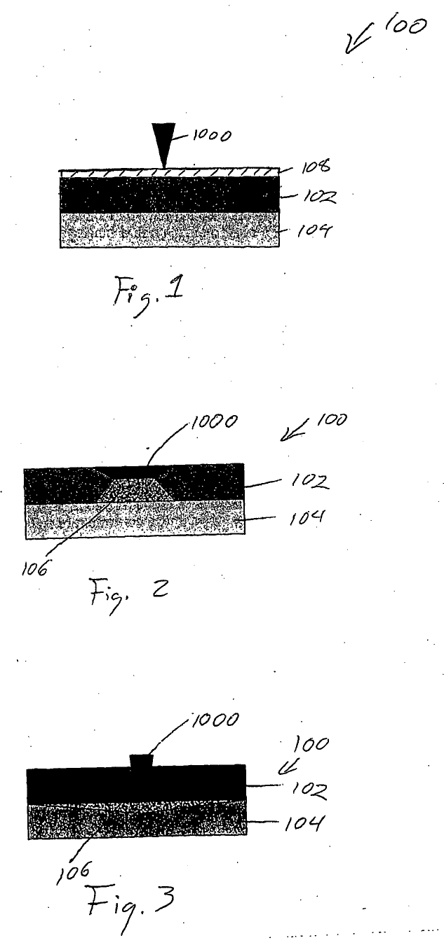

Referring to the drawings, and in particular to FIG. 1, a reinforced armor system 100 is shown. The armor panel system 100 includes a strike panel 102 supported by a backing panel 104. A projectile 1000 is shown at the precise moment of initial engagement with the strike panel and prior to the armor panel absorbing any of the energy of the projectile 1000. The strike panel materials 102 typically are hardened to allow the strike face to flatten, shatter and deflect the projectile 1000, as shown in FIG. 2. To support the strike panel 102 correctly, the composite backing panel 104 is utilized that has the characteristics of toughness and stiffness. The correct combination of a hardened strike panel 102 with a stiff and tough backing panel 104 improves the effectiveness of ballistic defense. As shown in FIG. 2, when the projectile 1000 strikes the armor panel 100, the projectile 1000 is preferably flattened. The flattening of the projectile 1000 at is impact creates a cone of pulverized material 106 directly behind the projectile 1000 that must be supported by the backing panel 104 during the very short duration of the ballistic striking event. The armor panel 100 may be a separate armor device for later mounting or may be incorporated into the surface of a structure such as a wall. Existing structures suitable for having armor panels 100 attached thereto include structures of cement block, brick, wood, stone, drywall, and stud walls and may be used for added tensile support.

It has also been found that the use of a thin layer 108 of the high elongation resin bonded over the front of the strike panel 102 provides improved performance. High elongation resin over the strike face eliminates the “spray” of pulverized granite and other materials from the front face of the panel and greatly controls any cracking. The bonded resin layer leads to reducing the amount of shrapnel associated with many types of armor. Excellent results have been achieved using 400 to 600% elongation polyurea as the outer layer 108. The outer layer 108 keeps the damaged area as small as possible and is invisible to the enemy from a distance. Moreover, the damage is easily repaired, as the pulverized dust remains contained in a crater “blister” where it could be fixed with a syringe of epoxy via injection. The outer layer 108 may be sprayed to the strike panel 102. The backing panel 104 may also be sprayed onto the strike panel 102 or molded to the strike panel 102 in some embodiments. This outer polymer layer can be reinforced with additional Hardwire to assist in very large projectile multi-hit performance. Further, tensile reinforcement applied directly to the strike face can increase the strike face weight efficiency by facilitating more complete strike face pulverization and projectile interaction.

As shown in FIG. 2, the pulverized material is well supported and not allowed to escape from the space between the strike panel 102 and the backing panel 104 and the resulting powder acts as an incompressible solid and works to continue to flatten and shatter the projectile 1000. This prevents the projectile 1000 from passing through the armor 100 and/or creating dangerous fragments. The backing panel 104 should abut the strike panel 102

As shown in FIG. 3, it is important that the backing panel 104 not deflect from the strike panel 102 during the ballistic event. As shown in FIG. 3, if the backing panel deflects during the event, the powder escapes behind the strike panel and the projectile 1000 carries through the backing panel 104 in its nearly original form and configuration, without unnecessary flattening occurring. If the projectile 1000 is not sufficiently flattened or shattered, the projectile 1000 simply passes through the strike panel 102 and backing panel 104 and onto the original target. It can be seen that the backing panel 104 must remain attached to the strike panel 102 so that the system 100 performs properly and provides effective protection, as shown in FIG. 2.

In addition to superior bending and stiffness attributes, the backing panel 104 must have superior tensile modulus and strength directly behind the strike panel 102 for the strike panel 102 to have instantaneous tensile capability during the ballistic event. Good strike face materials have the properties of high hardness and good compressive properties with the highest possible tensile capacity. As most hardened strike face materials possess low tensile capacities, it is important that the backing panel material directly behind the strike face 102 have maximum possible tensile stiffness and strength. To limit the dilation of the strike panel 102 and subsequent cracking of the material directly behind the strike panel 102, the backing panel material should have a fiber modulus in excess of 30 MSI. The backing panel 104 limits the dilation of the strike panel 102 that occurs as the projectile works to push its way into the composite armor 100. The area of peak stress occurs directly behind the strike panel powder cone 106. The backing panel 104 must have a material that has high tensile strength to resist tensile failure and splitting to stresses caused by pressure exerted by the strike panel powder 106. In addition, due to strains caused by the pressure of the powder cone 106, the backing panel 104 must have material that has high strain capability. Should the fibers of the backing panel 104 break, ductility combined with strain capability produces the largest energy absorption and the best probability of stopping the projectile 1000. In the most weight efficient armor systems, the strike face is reinforced with the backing panel 104 having material immediately adjacent to the strike face that has the highest possible stiffness and strength, while the rest of the backing panel 104 can be made from a second material that possess excellent tensile strength and superior elongation properties at lower initial stiffness levels.

Since lightweight composite armors have layers, it is critical to build in the maximum amount of delamination resistance possible. Very high punching shear loads generated by the pressure of the powder cone 106 work to break the composite at the weakest point, the interlaminar boundary, causing delamination. Therefore, delamination is also a critical problem that must be addressed. In multi-hit scenarios, the delamination failure becomes even more critical.

Referring now to FIGS. 4-6, there is shown a second embodiment of a composite armor panel system, generally designated 200, according to the principles of the present invention. As shown in FIGS. 7-9, a third embodiment of a reinforced armor system is shown, designated 300. The armor panel system 200 and the armor panel system 300 are similar in all respects except for core materials 208 and 318, which differ in their thickness and typically, in their composition. The armor panel systems 200 and 300 include strike panels 202 and 302 respectively. The strike panels 202 and 302 are mounted to a composite backing panel 204 and 304. The strike panels 202 and 302 may also include an outer bonding layer similar to layer 108 shown in FIG. 1. As shown in FIGS. 4-9, each of the backing panels 204 and 304 includes first reinforcement layers 206 and 306, core materials 208 and 318, and second reinforcement layers 210 and 310. The reinforcement layers 206, 306, 210 and 310 include a first reinforcement layer 212 and 312. The reinforcement layers 212 and 312 in the embodiment shown have support layers 214 and 314, such as a layer of Hardwire™, with fibers in a first orientation and one or more layers 216 and 316, with fibers in a second orientation. The embedded twisted Hardwire™ cords in a supporting matrix allow for greater elongation of the fibers without breaking, thereby providing improved support. Staples, reinforced rivets or other through connectors 222 and 322 extend through the composite backing panels 204 and 304. It can be appreciated that as shown in FIGS. 5, 6, 8 and 9, the pulverized material 220 and 320 that forms upon impact of a projectile 1000 differ in shape depending upon the core materials 208 and 308 utilized.

According to the present invention, testing has found suitable materials for the blast resistant strike panel 202 and 302 that are readily available and inexpensive. It was found that desired low cost materials, including hard stone such as types of granite, ceramic tile, brick, glass and hardened concrete such as ultra high strength concrete provide satisfactory results while being relatively inexpensive. As granite has strength and hardness and a high hardness-to-density ratio as well as good availability, even in thin cut tile form, it has been found to be an excellent strike face material. It has been found that for superior ballistic performance, hardness, compressive strength, MOR and flexural strength should be maximized while density and grain size should be minimized. Good results were achieved when using specific fine grain and high compressive flex strength materials.

Readily available Lac Du Bonnet stone from the Lac Du Bonnet Quarry in Manitoba, Canada provided more than satisfactory results. Effective results were obtained when the strike face compressive strength was greater than 19,000 pounds per square inch, the moment of rupture was greater than 1,200 pounds per square inch, the flex strength was over 1,500, and density was approximately 160 pounds per square foot with high hardness. Moreover, fine grain structures were preferred over large swirled grain structures. Testing showed that the fine grain structure showed superior multi-hit performance and minimized the affected impact zone. With a suitable strike panel material, the projectile forms a defined cone of impact with little residual cracking or shattering extending away from the impact area. Such a “drill through” characteristic of fine grain granite is preferred for multi-hit performance. In addition, as the fine grained granite limits cracking, large stone tiles can be used for armor panels, further reducing manufacturing costs and time. Typical thicknesses used for smaller arms or greater energy projectiles range from 0.1 inch to 2 inches. It has also been found that other stone materials with hardness and other physical attributes similar to granite also provide satisfactory results.

In addition, it was surprisingly found that some granite materials also provided a degree of radar stealth due to the nature of the material's surface. The randomly distributed micro particles in high strength granite provides reflecting planes for wave energy dissipation. This achieves an intrinsic, low cost radar absorbing face material for armor systems of any vehicle. It was also found that granite and other natural stones provide excellent protection against shaped charge weapons.

Cementitious materials, such as ultra high strength concrete, including the material known as Ductile™ was also found to be an excellent strike face material. Ductile™ is a mixture of concrete and fine aggregate and contains fine short wire reinforcements and exhibits a typical density greater than 150 pounds per cubic foot, a compressive strength of approximately 20,000 to 30,000 pounds per square inch and excellent fracturing toughness with improved tensile capacity.

Yet another inexpensive suitable strike panel material is ceramic tile. Porcelain ceramic tile provides low cost, high hardness, fracture toughness and failure characteristics, which proved to be an excellent choice for low cost strike face materials. Ceramics of aluminum oxide, silicone carbide, boron nitride and boron silicone nitride have tested well. Even common materials as typical floor tile, often used in bathrooms or kitchens, showed excellent single hit and multi-hit capacity.

Even typical metal plate armor showed surprisingly improved performance when integrated into the armor system 100. The blast resistant panel 102 of metal plate supported with the supporting layers 104 exhibited superior properties. Suitable materials for the metal plate include, aluminum, steel and alloys thereof, titanium, and other alloys and hardened metal materials.

An acceptable backing panel 104 has a sufficiently hard and stiff material that does not split or separate from the strike panel, as shown in FIG. 3. Improved results have been achieved with a Hardwire™ reinforced thermoplastic and thermoset composite. The Hardwire™ reinforcement layers 206, 306, 210 and 310 shown are unidirectional reinforcement materials arranged in a simple 0/90 configuration. Even better results can be achieved with more complex 0/90/+−45 configurations. In the embodiment shown, the layers 212, 214 and 216 are arranged so that the wire cords of the layers 214 and 314 extend perpendicular to the cords of layers 216 and 316, respectively. It has been found that four layers of Hardwire™ reinforcement provide excellent performance when tested against AK47 full metal jacket rounds. Eight layers provided even better performance against many weapons. Other maximizing wire density configurations improve the contribution of each layer in the ballistic system. Moreover, other cord types provide superior results and low lay length cords provide superior performance as the lower lay length cords are believed to provide higher immediate stiffness for both tensile and bending to the hard face resulting in improved ballistic performance. Suitable materials for the reinforcing fibers include: e glass, s glass, Aramid, oriented polyethylene, Dynima, carbon and several metallic materials. Metal wires of materials such as brass, zinc, steel and these materials coated with rubber or polymers are also suitable. It can be appreciated that other types of cords and more or fewer layers may be used depending upon the projectile energy. The fibers preferably have an elongation of about 1% to 10% or more.

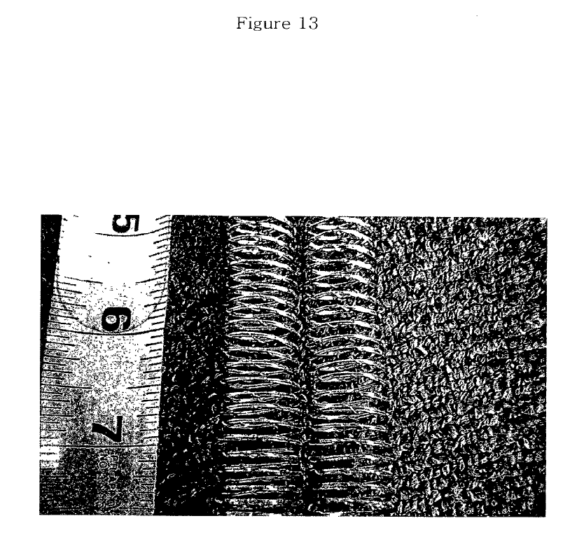

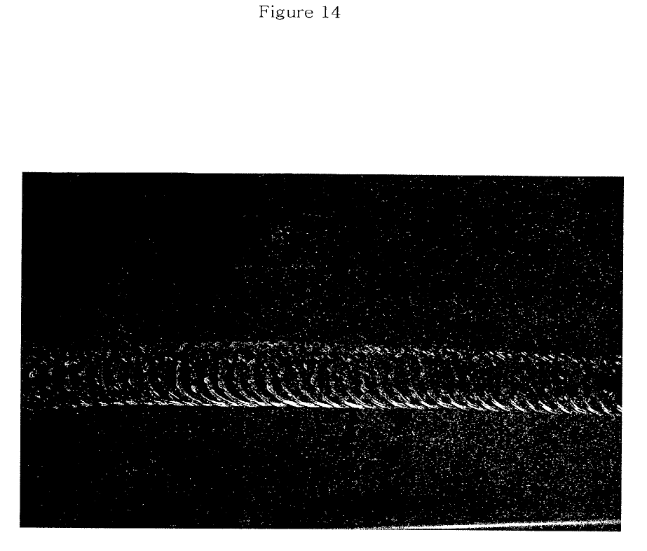

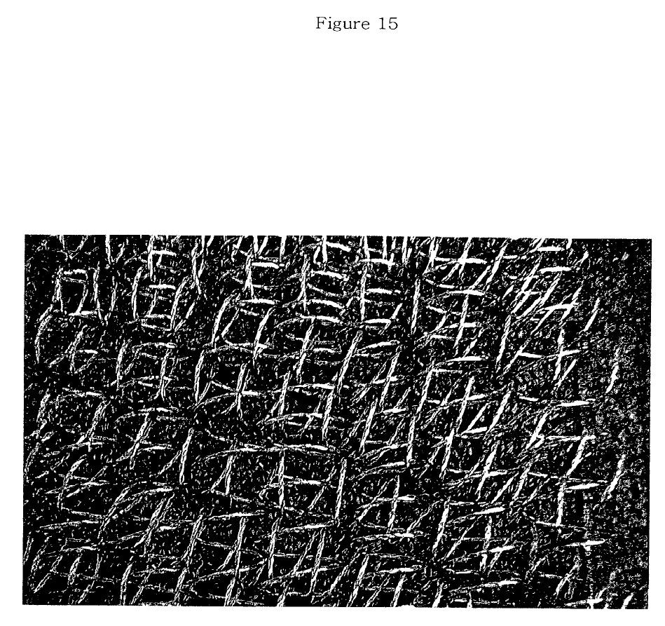

In addition, other nonparallel cord configurations in addition to a 0/90 configuration provide enhanced performance. Moreover, nonlinear fiber configurations provide advantageous support when set in the resinous matrix. Examples of suitable nonlinear wire configurations are shown in FIGS. 13-18 that may elongate by deforming and straightening to a further degree than straight wires without breaking. These arrangements provide improved support as the cords and wires are straightened in addition to possible stretching the of the wire material upon impact. As shown in FIG. 13, reinforcing wires are wound in a helical spring type configuration in the backing panel 104. As the layer is stretched, the helix straightens without the wire breaking, providing improved elongation and toughness. The helical configuration may be modified as shown in FIGS. 14 and 15. The reinforcing wires can be wound in a flattened helical configuration as FIG. 14 that provide for stretching of the helix. The helical springs may also be intertwined to form a woven network spreading through the layers of the backing panel 104.

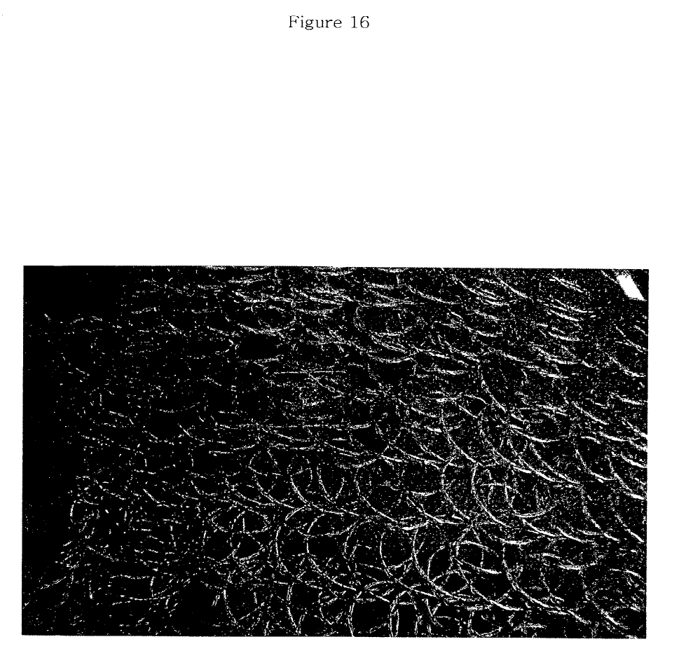

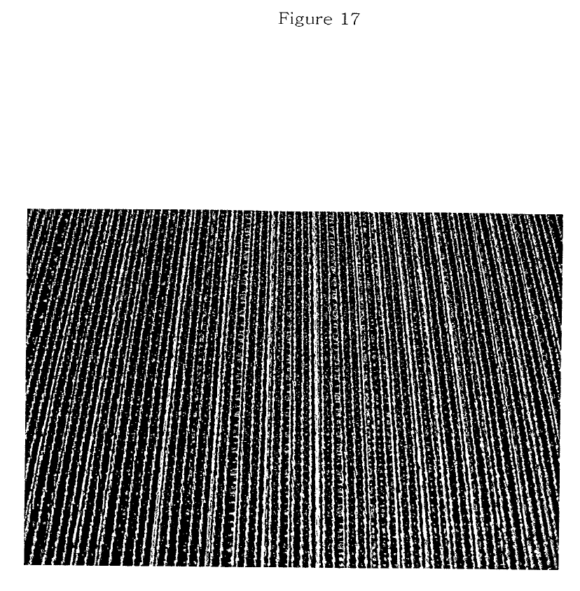

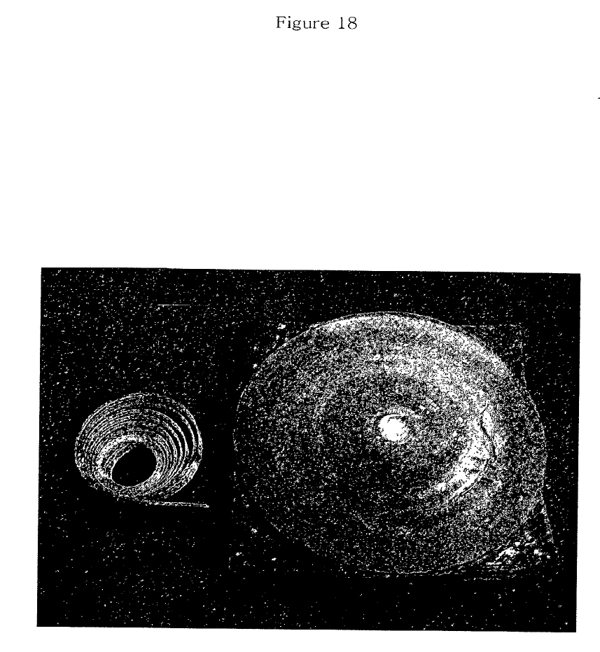

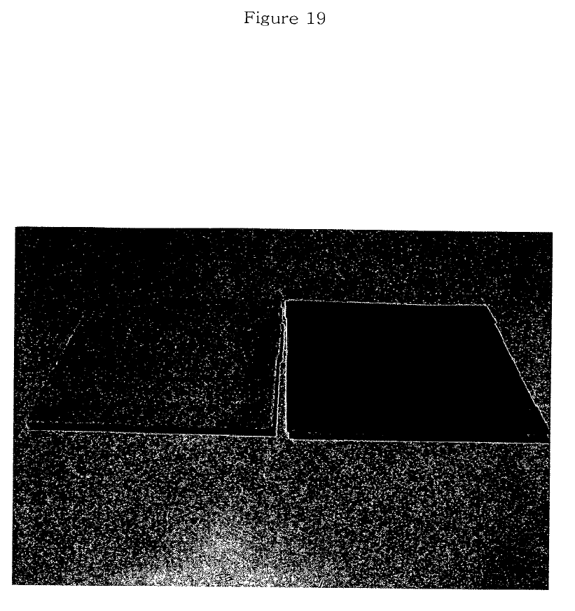

In addition to the helical configurations, other fiber arrangements provide greater elongation with breaking. As shown in FIG. 16, discontinuous wires formed into loops may be pulled under strain to straighten. Continuous wires formed in a spiral configuration provide for stretching in several directions due to the continuous changing orientation of a spiral, as shown in FIG. 18. High twist reinforcing wires embedded in a unidirectional tape as shown in FIG. 17 provide improved toughness and support. The twisted cords may also be intertwined and/or formed into the nonlinear shapes; such as helix, loop, spiral or other shape, to compound the elongation properties. The reinforcing fibers may also be individual deformed wires, such as formed in a corrugated pattern, that provides for straightening and elongation. Wires or fibers may also be injected intermediate layers of the armor system 100. The fibers may also be oriented in two-directional, three-directional or four-directional arrangements.

Resin types for the Hardwire™ with higher stiffness resins such as epoxy obtained excellent results. Testing showed that resins including high strength and high elongation thermoset and thermoplastic resins were well suited. Materials such as thermoset epoxy, thermoplastic epoxy, polyester, polyurea, vinylester, urethane, rubber, PBT, polyethylene, polyurethane, nylon, ABS, high impact polystyrene, lexan, polycarbonate and oriented polypropylene performed well. Resins above 30% elongation, such as most thermoplastics are preferred and extremely effective in multi-hit tests. Moreover, resins having a modulus of elasticity of 250,000 psi or greater performed well and superior results were obtained with resins having a modulus of elasticity greater than 300,000 psi, indicating good stiffness. Testing shows that the higher modulus resins appear to stretch more and absorb more energy. As toughness and stiffness are related, a superior compromise material had 60-80% elongation and a modulus of elasticity of 320,000 psi. Lower modulus, high elongation resins show superior performance against higher energy rounds such as bomb fragments.

Other materials for the backing panel 104 that maybe be reinforced include wood and many cementitious materials. Reinforcing fibers are embedded into the materials in a manner similar to that for a resinous matrix for improved support of the strike face.

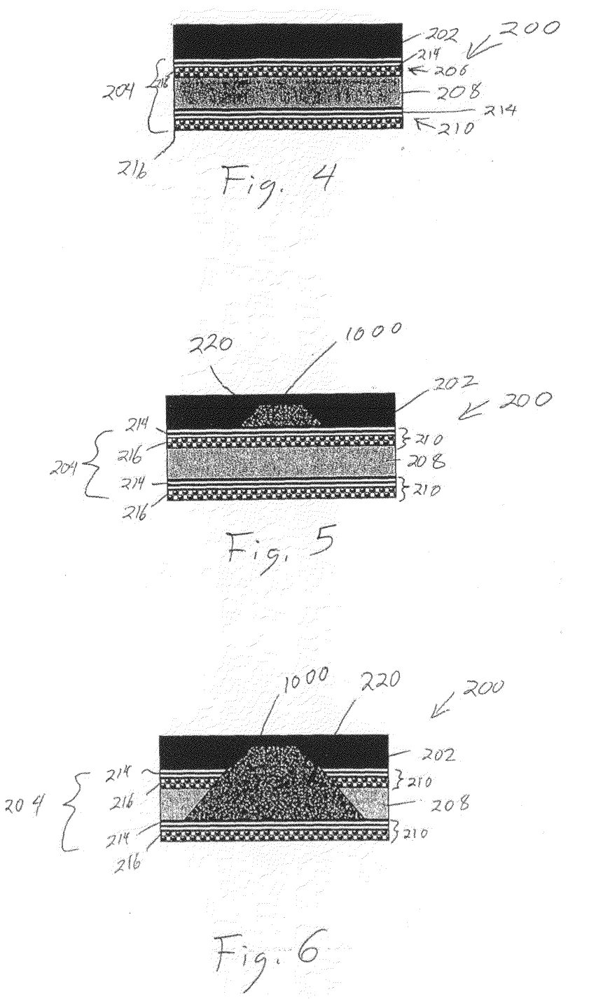

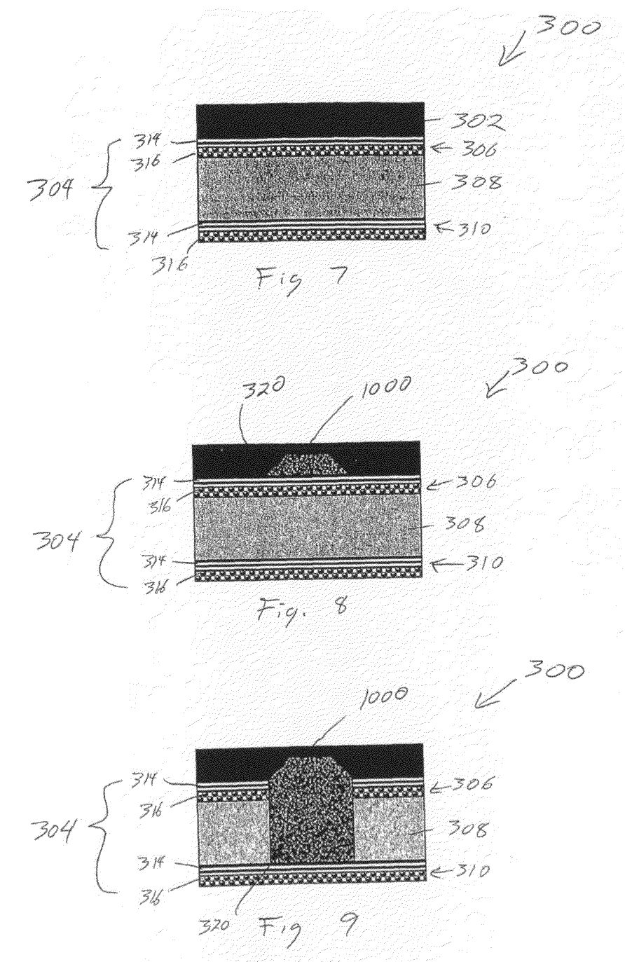

The backing panels 204 and 304 may include a core 208 and 308, respectively to provide adequate bending stiffness compared to glass fibers. One preferred configuration was to use the core materials between two equal skins of 0/90 twisted cord layers (Hardwire™). Good results were obtained with core materials in the 5 to 15 pounds per cubic foot range such as PVC foam, urethane foam, balsam wood or plywood. Superior results were obtained from higher density cores such as solid ABS, PVC, Lexan, PET epoxy or other typical engineering non-foam polymers that were configured to be an equal weight per area as a lower density material. Testing indicated that thinner denser cores typically perform better than thicker lighter cores. As shown in FIGS. 6 and 9, the improved performance was attributed to how the shockwave traveled to the core and how well the front face of the 0/90 twisted cord layer transferred through the core and to the rear face of the laminate. It was noted that the high density core panel 200 shown in FIG. 6 spreads the impact cone, while the lower density core panel 300 shown in FIG. 9 may allow the impact cone to simply “plug through” the backing panel 304. It has been found that the high density core 208 further works to absorb the impact energy as opposed to the lower density core and spread the energy beyond the impact cone. Performance is improved if the backer panel is roughly the same thickness as the strike panel and the core thickness is roughly the same thickness or larger than the sum of the two skin thicknesses.

Connectors 222 and 322, such as staples, interlaminar stitches or rivets, may be used to reinforce the panel in the Z direction to resist punching shear from the impact created by the projectile 1000. It has been found that the staples 222 and 322 are preferred for manufacturing ease, strength and ductile response. The ability to accept staples is such as with Hardwire™ laminates is rare, as typical laminates with traditional fibers are not able to take the pressure of the loads imposed by staples. Hardwire™ steel fibers are unaffected by the loads applied during stapling. Although all plies can be stapled together, testing indicated that it is more important that the last two layers in the backing panel composite be stapled (the bottom layers as shown in FIGS. 4-9). Staples can simply be inserted into the laminate relying on the adhesion from the resin. However, for improved results, the staples are folded over in a manner similar to a common paper staple so that mechanical engagement also occurs. The staples hold the Hardwire™ layers together and severely retard delamination and have significant multi-hit performance. An alternative method might utilize Z directional stitching in applications where the materials and operations allow it.

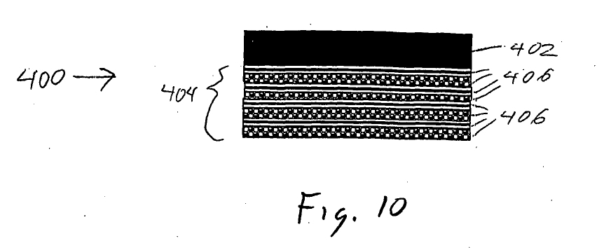

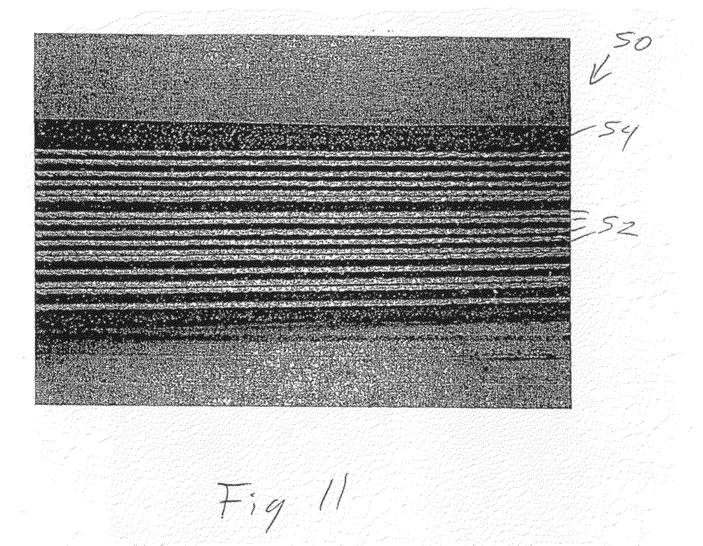

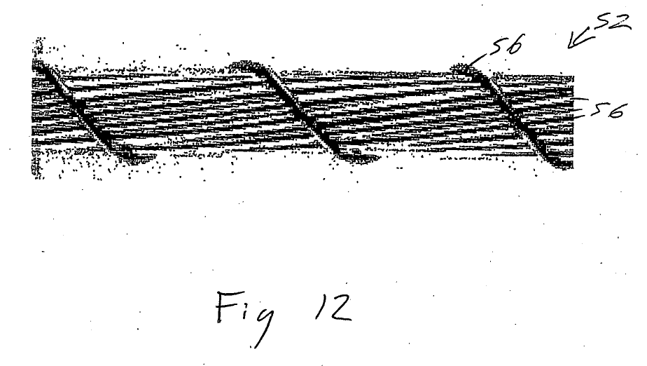

Referring to FIG. 10, a further armor panel system 400 is shown. The armor system 400 includes a strike panel 402 and a backing panel 404. The backing panel 404 does not utilize a core as in the other embodiments, but uses a stack of reinforcement layers 406, such as twisted wire reinforcement layers. A typical Hardwire™ assembly uses 4 layers of 23 wires per inch material and a core to make a 0.5-inch thick backer plate. The combined use of larger gapped Hardwire™ material and a high elongation resin matrix where the high elongation resin can “button” through the material improves performance and eliminates the need for staples and makes a very tough ballistic composite for multi-hit performance. The embodiment in FIG. 10 utilizes 8 layers of 12 wires per inch material with wider gaps between the reinforcement wire bundles. The greater number of layers offset the larger gaps and fewer wires so that the same number of wires is used. A typical stack is approximately 0.5 inches thick. The panel 400 has wires evenly distributed throughout the thickness and is easily molded as it is more porous and easy to maintain the location of the plies in the mold. Moreover the material is homogeneous with high toughness due to the button effect of the polymer on itself as opposed to a clean “plane” of delamination dominated by the adhesion of the matrix to the dense wire.

Referring now to FIG. 11, there is shown a typical Hardwire™ twisted cord layer, generally designated 50. Hardwire is disclosed in U.S. Published Patent Application No. 2002/0037409 A1 to Tunis, incorporated herein by reference. The Hardwire™ layer includes cords 52 and a tape material 54. Each of the cords 52 includes multiple wires. In the cord embodiment shown in FIG. 12, a single fiber strand 56 extends around the bundle of fibers 56. However, other cord types with other Hardwire™ configurations have also proven to provide successful armor reinforcement.

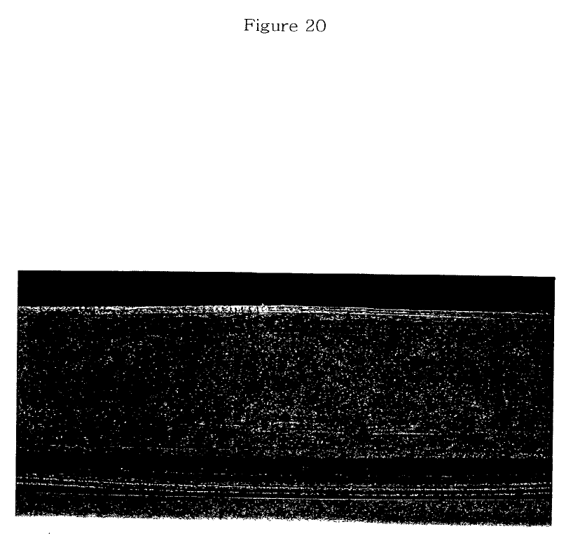

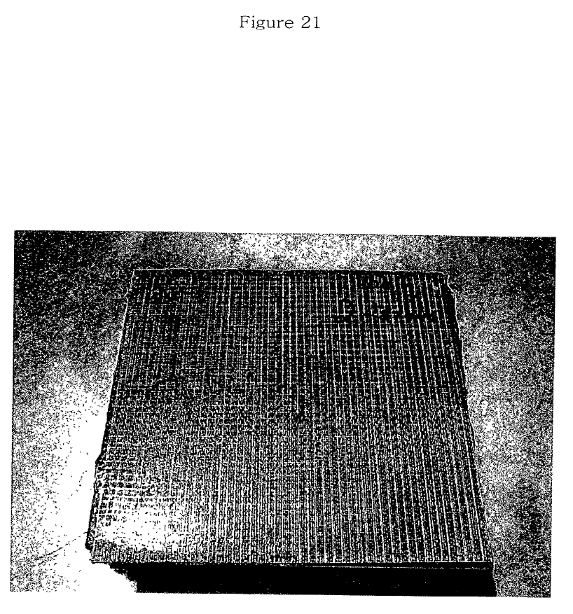

In a further embodiment, as shown in FIGS. 19-21, material of hook and loop fasteners, more commonly know as Velcro™, is used to attached the strike panel 102 to the backing panel 104. The hook and loop fastener material covers the entire face of the strike panel 102 and provides secure connection between the strike panel 102 and the backing panel 104.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. An armor system comprising:
a first layer having high hardness defining a blast resistant front strike face;
a second composite layer affixed to a rear of the first layer, wherein the composite comprises reinforcement fibers embedded in a surrounding matrix.

2. An armor system according to claim 1, wherein the fibers comprise wires deformed in a nonlinear configuration.

3. An armor system according to claim 1, wherein the second layer comprises a twisted metallic cord in the matrix.

4. An armor system according to claim 1, wherein the first layer comprises material selected from the group consisting of hard stone, hardened concrete and ceramic tile.

5. An armor system according to claim 2, wherein the first layer comprises material selected from the group consisting of hard stone, hardened concrete and ceramic tile.

6. An armor system according to claim 1, wherein the first layer comprises hard stone.

7. An armor system according to claim 6, wherein the hard stone comprises granite.

8. An armor system according to claim 1, wherein the armor system is mounted to an existing structure and wherein the existing structure provides tensile support.

9. An armor system according to claim 8, wherein the existing structure comprises a structure selected from the group consisting of: cement block, brick, wood, stone, drywall, and a stud wall.

10. An armor system according to claim 1, wherein the fibers comprise a material having an elongation of about 1% to about 10%.

11. An armor system according to claim 1, wherein the fibers are arranged in the matrix at random orientations.

12. An armor system according to claim 1, wherein the fibers are arranged in the matrix in a swirled pattern.

13. An armor system according to claim 1, wherein the fibers are arranged in the matrix in a helical pattern.

14. An armor system according to claim 1, wherein the fibers are arranged in the matrix in a corrugated pattern.

15. An armor system according to claim 1, wherein the second layer comprises unidirectional tape.

16. An armor system according to claim 1, wherein the second layer comprises woven or knitted fabrics.

17. An armor system according to claim 1, wherein the fibers comprise chopped wires.

18. An armor system according to claim 1, wherein the reinforced material comprises staples, stitches or reinforced rivets.

19. An armor system according to claim 1, wherein the second layer comprises a resin having at least 30% elongation.

20. An armor system according to claim 19, wherein the second layer comprises a resin having a modulus of elasticity of at least 250,000 pounds per square inch.

21. An armor system according to claim 1, wherein the reinforced material comprises tensile elements injected intermediate the first and second layers.

22. An armor system according to claim 1, wherein the first layer attaches to the second layer with adhesive.

23. An armor system according to claim 1, wherein the first layer attaches to the second layer with hook and loop fasteners.

24. An armor system according to claim 1, wherein the second layer comprises a resin selected from the group consisting of: polyurea, urethane, PBT, Lexan, and polypropylene.

25. An armor system according to claim 1, wherein the first layer comprises fine grained stone.

26. An armor system according to claim 1, wherein the first layer is selected from the group consisting of: brick, glass, and ceramic tile.

27. An armor system according to claim 1, wherein the first layer comprises a ceramic selected from the group consisting of: aluminum oxide, silicone carbide, boron nitride, and boron silicon nitride.

28. An armor system according to claim 1, wherein the first layer comprises a metal plate.

29. An armor system according to claim 28, wherein the metal plate comprises a material selected from the group consisting of: aluminum, steel, steel alloy, and titanium.

30. An armor system according to claim 1, wherein the first layer comprises balls of material selected from the group consisting of: glass, ceramic, and metal.

31. An armor system according to claim 1, wherein the first layer comprises high strength concrete.

32. An armor system according to claim 1, further comprising a third layer, wherein the third layer comprises a material reinforced with wires attached to the first layer on the front strike face.

33. An armor system according to claim 1, wherein the second layer comprises a composite having a thermoset or a thermoplastic resin, and reinforcing fibers disposed therein.

34. An armor system according to claim 33, wherein the reinforcing fibers comprise advanced composite fibers.

35. An armor system according to claim 33, wherein the reinforcing fibers are selected from the group consisting of: e glass, s glass, Aramid, oriented polyethylene, Dynima, carbon.

36. An armor system according to claim 33, wherein the reinforcing fibers comprise continuous fibers.

37. An armor system according to claim 33, wherein the reinforcing fibers comprise discontinuous fibers.

38. An armor system according to claim 33, wherein the resin is selected from the group consisting of: epoxy, polyester, urethane, polyurea, vinylester, polyethylene, ABS, high impact polystyrene, polypropylene, oriented polypropylene, nylon, Lexan, and polycarbonate.

39. An armor system according to claim 1, wherein the second layer comprises a plastic backer panel.

40. An armor system according to claim 39, wherein the plastic backer panel comprises a pure plastic resin or rubber.

41. An armor system according to claim 1, wherein the plastic backer panel comprises a polymer selected from the group consisting of: thermoplastic epoxy, thermoset of epoxy, polyester, urethane, polyurea, vinylester, polyurethane, ABS, high impact polystyrene, polypropylene, oriented polypropylene, nylon, Lexan, polycarbonate.

42. An armor system according to claim 39, further comprising a second plastic backer panel mounted to an opposite side of the first layer.

43. An armor system according to claim 39, wherein the plastic backer panel comprises a plate molded to the first layer.

44. An armor system according to claim 39, wherein the plastic backer panel comprises a plate sprayed to the first layer.

45. An armor system according to claim 44, wherein the plastic backer panel comprises a polyurea or a polyurethane.

46. An armor system according to claim 39, wherein the plastic backer panel comprises a plate glued to the first layer.

47. An armor system comprising:
a blast and ballistic resistant strike panel of hard stone, ceramic or a cementitious material;
a backing panel attached to the strike panel and supporting the strike panel, the backing panel having a core with at least one reinforcement layer of fibers set in a resinous material.

48. An armor system according to claim 47, wherein the backing panel comprises a wire cord reinforced material.

49. An armor system according to claim 48, further comprising staples extending through the backing panel.

50. An armor system according to claim 48, wherein the backing panel comprises a Hardwire™ twisted cord layer.

51. An armor system according to claim 47, wherein the strike panel comprises granite.

52. An armor system according to claim 47, wherein the strike panel comprises material selected from the group consisting of granite, hardened concrete and ceramic tile.

53. An armor system according to claim 48, wherein the backing panel comprises a core and a composite twisted cord layer.

54. An armor system according to claim 53, wherein the backing panel comprises a second Hardwire™ layer.

55. An armor system according to claim 53, wherein the backing panel comprises a second Hardwire™ layer proximate a first Hardwire™ layer with wires oriented transverse to one another.

56. An armor system comprising:
a blast and ballistic resistant strike panel comprising material selected from the group consisting of granite, hardened concrete and ceramic tile;
a backing panel attached to the strike panel and supporting the strike panel, the backing panel having a core and a reinforcement layer attached to the core, the reinforcement layer comprising a resin with reinforcement fibers set in the resin.

57. An armor system according to claim 56, wherein the backing panel comprises Hardwire™ reinforcement layers.

58. An armor system according to claim 57, wherein the backing panel comprises a first Hardwire™ layer proximate a second Hardwire™ layer with wires oriented transverse to one another.

59. An armor system according to claim 56, wherein the backing panel comprises a plurality of wire reinforced layers.

60. An armor system according to claim 56, wherein the wire-reinforced layers comprise layers having about 12 wires per inch.

61. An armor system according to claim 56, wherein the backing panels comprises eight or more wire reinforced layers.

62. An armor system according to claim 56, further comprising a resin layer on an outer face of the strike panel.

63. A ballistic resistant armor panel comprising a stone panel reinforced by a composite reinforcing layer attached to a rear of the stone panel, wherein the reinforcing layer composite comprises high strength twisted metallic cords embedded in a resinous matrix.

64. A ballistic resistant armor panel comprising a stone-like panel reinforced by a reinforcing layer attached to a rear of the stone-like panel, wherein the reinforcing layer comprises resinous or plastic material.

65. A panel according to claim 64, further comprising a reinforcing layer attached to a front of the stone-like panel.

66. A panel according to claim 64, wherein the reinforcing layer is molded to the stone-like panel.

67. A panel according to claim 64, wherein the reinforcing layer is sprayed on to the stone-like panel.

68. An armor system according to claim 1, wherein the first layer comprises granite.

69. An armor system according to claim 68, wherein the fibers of the second layer comprise twisted steel cord or steel wire.

70. An armor system according to claim 68, wherein the fibers of the second layer comprise glass fibers.

71. An armor system according to claim 68, wherein the matrix of the second layer comprises polyurea.

72. An armor system according to claim 68, wherein the granite is protectable against a shaped charge weapon.

73. An armor system according to claim 1, wherein the first layer comprises a radar-absorbing material.

74. An armor system according to claim 1, wherein the fibers comprise a material having an elongation of at least 1.

75. An armor system according to claim 1, wherein the fibers comprise a material having an elongation of at least 10%.

76. An armor system according to claim 1, wherein the fibers comprise twisted steel cord or steel wire.

77. An armor system according to claim 76, wherein the twisted steel cord or steel wire is layered in a composite at various orientations.

78. An armor system according to claim 76, wherein the twisted steel cord or steel wire is layered in a composite in a swirled pattern.

79. An armor system according to claim 76, wherein the twisted steel cord or steel wire is oriented in a helical spring pattern or corrugated to enhance elongation beyond the elongation of the base cord.

80. An armor system according to claim 76, wherein the twisted steel cord or steel wire is layered in a composite using unidirectional tapes.

81. An armor system according to claim 76, wherein the twisted steel cord or steel wire is layered in a composite using woven or knitted fabrics.

82. An armor system according to claim 76, wherein the twisted steel cord or steel wire is layered in a composite using chopped twisted cords.

83. An armor system according to claim 1, wherein the fibers comprise twisted steel cord or steel wire and further comprising additional twisted steel cord or steel wire on the front strike face of the first layer.

84. An armor system according to claim 1, further comprising a layer of polyurea bonded to the front strike face of the first layer.

85. An armor system according to claim 1, wherein the armor system comprises a stand-alone armor assembly.

86. An armor system according to claim 1, wherein the armor system is retrofit to an existing structure.

87. An armor system according to claim 1, wherein the armor system is incorporated into another surface.

88. An armor system according to claim 15, wherein the second layer comprises a plurality of unidirectional tapes layered in various orientations.

89. An armor system according to claim 31, wherein the strike face of the high strength concrete is reinforced with high strength wire or wire cord.

90. A panel according to claim 63, wherein the stone panel is comprised of granite.

91. A panel according to claim 64, wherein the stone-like panel is comprised of granite.

92. A panel according to claim 91, wherein the reinforcing layer comprises fibers embedded in the resinous or plastic material.

93. A panel according to claim 91, wherein the reinforcing layer comprises high strength twisted metallic cords embedded in the resinous or plastic material.

94. A ballistic resistant armor panel comprising a granite panel reinforced by a reinforcing layer attached to a rear of the granite panel, wherein the reinforcing layer comprises high strength twisted metallic cords embedded in a matrix material.

95. A ballistic resistant armor panel comprising a granite panel reinforced by a reinforcing layer attached to a rear of the granite panel, wherein the reinforcing layer comprises a composite material.

96. A ballistic resistant armor panel according to claim 95, wherein the composite material of the reinforcing layer comprises glass fibers embedded in a matrix material.

97. A ballistic resistant armor panel according to claim 95, wherein the composite material of the reinforcing layer comprises fibers embedded in a resinous, plastic, or cementitious matrix material.
